(19) United States
(12) Patent Application Publication
(10) Pub. No.: US 2018/0071057 A1
(43) Pub. Date: Mar. 15, 2018

(54) Programmable orthodontic indexing guide and bracket pin assembly and method of use

(71) Applicant: Robert T Rudman, Denver, CO (US)

(72) Inventor: Robert T Rudman, Denver, CO (US)

(21) Appl. No.: 15/732,065

(22) Filed: Sep. 12, 2017

(51) Int. Cl. A61C 7/14; A61C 7/00; A61C 7/34

(52) U.S. Cl. CPC A61C 7/146; A61C 7/023; A61C 7/34; A61C 7/002

(57) ABSTRACT

The present invention is directed to indirect bonding orthodontic brackets to a patient's teeth. A geometric index pin is attached to the orthodontic bracket enabling the orthodontic bracket to be precisely held by a plastic tray. A computer program positions the index pin/bracket combination for a patient's teeth in a determined position and designs the tray to carry each bracket to the patient's tooth in its computer selected position. The index pin eliminates the necessity for the tray material to enclose the bracket which results in a dental tray one third the normal dental tray which saves tray material and reduces the print time of the tray. The ease of removal of the tray from the teeth after placement of the brackets is enhanced by clipping the index pins with a pin cutter.

### FIELD OF THE INVENTION

The present invention relates to the field of orthodontics, more particularly to computer programmed indirect bracket bonding, more specifically to bracket holders and transfer trays.

### BACKGROUND OF THE INVENTION

Orthodontics is a branch of dentistry involving the treatment of irregularities in the teeth and jaws, including the use of braces. Orthodontic brackets are bonded to the teeth where a wire, called an arch wire, is attached to the bracket. The dentist determines the position of each bracket. The more accurately the brackets are placed the less the wires must be adjusted to achieve a perfect result. It is common that brackets must be repositioned on the teeth. The concept of not adjusting arch wires was advanced by Dr. Andrews when he developed the straight wire appliance (1970). The next concept was the brackets could be fitted more accurately on models of a patient's teeth. The brackets are positioned on the model and a dental tray was vacuumed over the model with the brackets. The brackets are positioned in the tray, the teeth are etched and the tray is placed over the patient's teeth where the brackets are bonded to the teeth.

The computer arrives and is programmed to determine the correct bracket position on a digital 3D image of the tooth. Digital scanners were developed which gave the computer a three- dimensional image of the patient's teeth. The computer can create a three-dimensional digital image of a model with an image of orthodontic brackets in the correct positions (U.S. Pat. No. 9,418,474). The computer is capable of creation of a three-dimensional creation of a tray to house the orthodontic brackets and program a 3D printer to form the tray with the receptacles for the brackets. This further refined in U.S. Pat. No. 9,622,834 which provides for scanning the patient's teeth.

The current state of the art requires digital trays rigid enough to not allow the brackets to migrate which makes the trays difficult to remove once the brackets have been placed in the mouth.

The removal difficulty increases the more crooked the teeth are. The hard trays make it hard to load the bracket. When brackets have been loaded in the tray the tray material encloses much of the bracket which makes it difficult to load the adhesive and limited access to remove the adhesive flash.

### SUMMARY OF THE INVENTION

The present invention Is directed to an indexing pin which is snap locked to an orthodontic bracket and a geometric tail which snap locks into a dental tray. The indexing pin is comprised of hard material such as rigid plastic. The indexing pin has a longitudinal tail with a geometric shape. The indexing pin has an opposite end which is precisely fitted to an orthodontic bracket to create a snap lock when the two are fitted together.

The function of the indexing pin is to precisely lock an orthodontic bracket in its computer chosen position to a clear orthodontic tray with minimal or no contact between the tray and the bracket. A tray is then vacuum molded over the model. The tray is trimmed to extend axially from the occlusal of the teeth to include the enclosure of the pins. This smaller tray has distinct advantages in access to the brackets and ease of removal of the tray following bonding of the brackets in the mouth.

The geometric male body snap-fits into a matching female receptacle in the tray. The geometry of the tail may include rings around the axis and a ring at the end.

In a preferred embodiment, the patient's teeth are scanned to a computer which determines the ideal positions of the bracket/attached pin combinations on the teeth. The computer then designs the reduced size tray containing the female receptacles for their corresponding mail indexing pins. The computer commands a 3D printer to print the occlusal index using a rigid plastic.

The male member of the bracket/pin combination is placed into its respective female receptacle. The teeth are etched and the tray with pasted brackets is placed on patient's teeth. Light cure paste is cured with a light cure gun through the clear plastic and the tray is removed.

In another embodiment, the bracket part of the indexing pin has four corners facing the bracket. Each corner has a rounded protrusion. Each bracket has four rounded recesses to match the rounded protrusions on the indexing pin. The protrusion/recess combination produces a locking affect when the pin and bracket are placed together.

### BRIEF DESCRIPTION OF THE DRAWINGS

FIG. 1 is a cross-sectional side view of a tooth and an attached orthodontic bracket/indexing pin combination wherein the pin is embedded in an occlusal index tray;

FIG. 2 is a view of an indexing pin on a tooth;

FIG. 3 is a view of an orthodontic bracket;

FIG. 4 is a view of an indexing pin attached to an orthodontic bracket;

FIG. 5 is a side perspective view of a bracket with an indexing pin;

FIG. 6 is a side perspective view of a bracket with an indexing pin with round ball corner protrusions seated in round ball recesses of a bracket;

FIG. 7 is a side perspective view of a bracket with round ball recesses to receive the ball protrusions of the indexing pin;

FIG. 8 is a side view of an indexing pin mounted to an orthodontic bracket;

FIG. 9 is a fragmented view disclosing the relationship of a tooth, bracket, indexing pin and an occlusal index;

FIG. 10 is a cross-sectional view of a tooth, an orthodontic bracket, indexing pin and occlusal index wherein a pin cutter is used to sever the occlusal index from the tooth;

FIG. 11 is a perspective fragmented view of an occlusal index and female indexing pin receptacle;

FIG. 12 is a perspective view of the occlusal index with embedded indexing pins;

FIG. 13 is a perspective view of the occlusal index/embedded indexing pin and bracket combination resting on a patient's teeth;

FIG. 14 is an occlusal view of the occlusal tray with the indexing pins and segmental cuts which enable one bracket to be re-bonded in the computer chosen position, and

FIG. 15 is a flow chart in the construction and use of the invention.

### DETAILED DESCRIPTION OF THE INVENTION

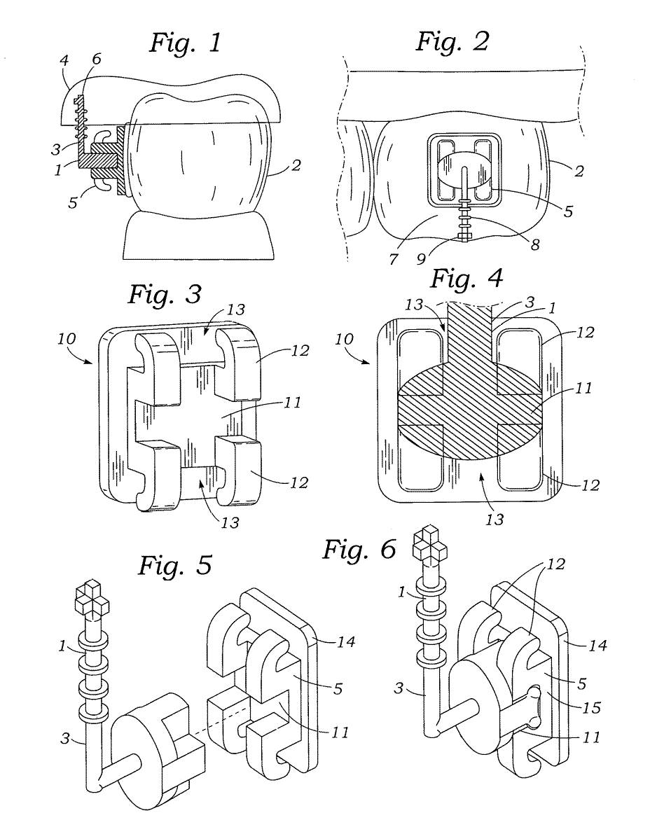

The invention is comprised of a digital indirect bonding assembly 1. FIG. 1 discloses the digital indirect bonding assembly 1 on a tooth 2. The assembly is comprised of a male indexing pin 3 with a second tail end 6, and an occlusal index tray 4. The indexing pin 3 is engaged with an orthodontic bracket 5. The indexing pin 3 is embedded in the occlusal index tray 4 at the second end 6. The bracket 5 position is determined by the position the male indexing pin 3 and is held in with ridges 8 and a geometric end 9, as shown in FIG. 2.

FIG. 2 shows the bracket 5 attached to a tooth 2 with the longitudinal tail 7 extending occlusally from the bracket 5. The longitudinal tail 7 has ridges 8 and a geometric end 8 to enhance the positional locking of the longitudinal tail 7 in the occlusal index tray 4. The bracket end of the male indexing pin 3 is snap fitted to the bracket 5.

FIG. 3 discloses an arch wire slot 11, bracket tie wings 12 and an interwing area 13 between the tie wings 12. The bracket end of the male indexing pin 3 is fitted to the arch wire slot 11 and interwing spaces 13.

FIG. 4 shows the indexing pin 1 mounted on the orthodontic bracket 10.

FIG. 5 shows the body of the male 3 indexing pin 1 parallel to the bracket pad 14 which allows access to the surface of the tooth 2, as shown in FIG. 1, to remove flash bonding material. The indexing pin 1 is shown shaped to fit an orthodontic bracket 5 with bracket slots 11.

FIG. 6 shows a perspective view of the bracket 5 with a side 15 view of the bracket wing 12. with the male indexing pin 3 extending towards the bracket pad 14 and fitted into the bracket slot 11.

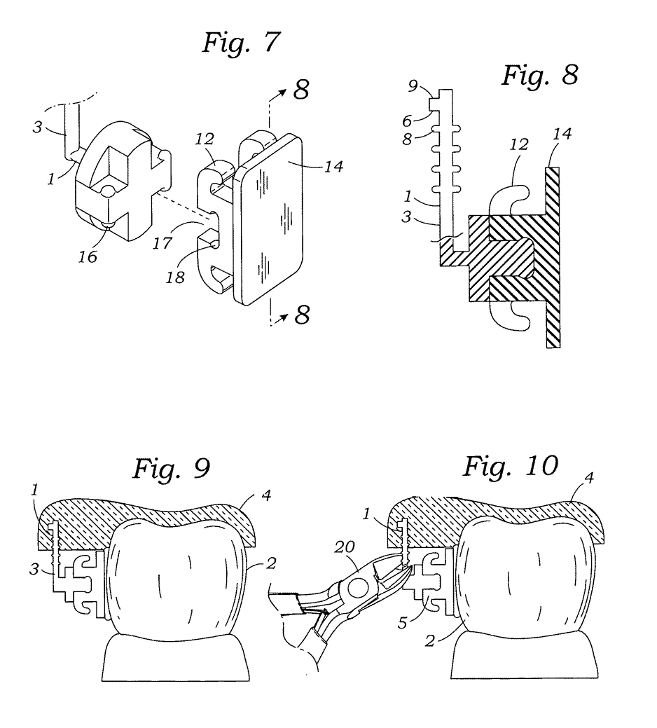

FIGS. 6 and 7 disclose miniature balls 16 and ball recesses 18 which produce a snap fit between the bracket 5 and the male indexing pin 3. FIG. 6 ‘discloses two of four inner corners with miniature balls 16. The balls 16 are fitted to the ball recesses 18 of the bracket 5 as seen in FIG. 7.

FIG. 8 shows the male indexing pin 3 with ridges 8 and a geometric end shape 9 at the tail end 6.

FIG. 9 discloses a version of the geometric end 9 which forms an unmistakable lock with the tray material 4.

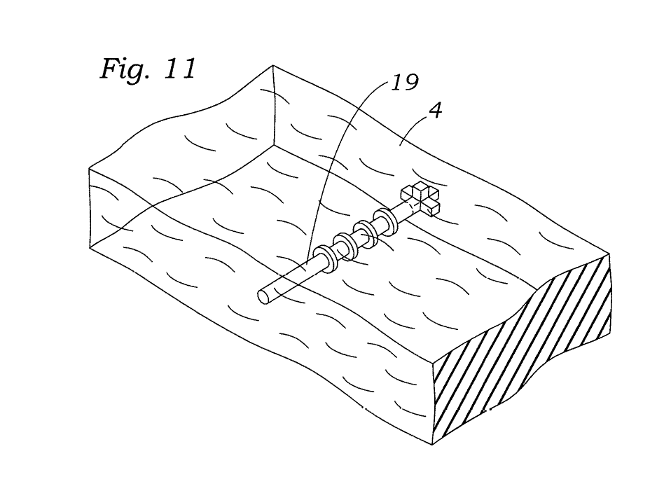

FIG. 10 reveals a bracket 5 with an attached indexing pin 1 which is embedded in the occlusal index 4. The computer directs a 3D printer to form the occlusal index 4. The occlusal index 4 is designed by the computer with a correctly positioned female receptacle 19, as shown in FIG. 11, for the male indexing pin 3. The male indexing pin 3 unmistakably snap locks into the female indexing pin receptacle 19. The occlusal index 4 is clear of the bracket 5. The male indexing pin 3 could be clipped after the hardening of the tray material to easily remove the occlusal index after the brackets are cured to the teeth 2, if necessary.

The female index receptacle 19 is shown in FIG. 11 in a section of the occlusal index 4 before a male indexing pin 3 is snap inserted.

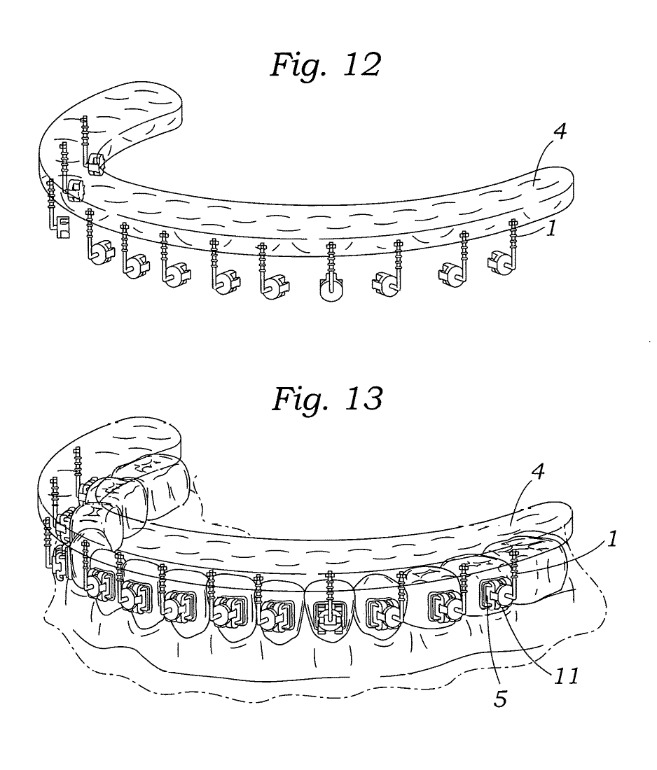

FIG. 12 shows the occlusal index 4 with attached index pins 1.

FIG. 13 shows the occlusal index 4 and attached index pins 1 placed on the teeth 2. The height of the occlusal index 4 is one half the height of a normal dental tray. The height of a dental tray is measured at a right angle to the occlusal plane (chewing surface) and is termed the axial height.

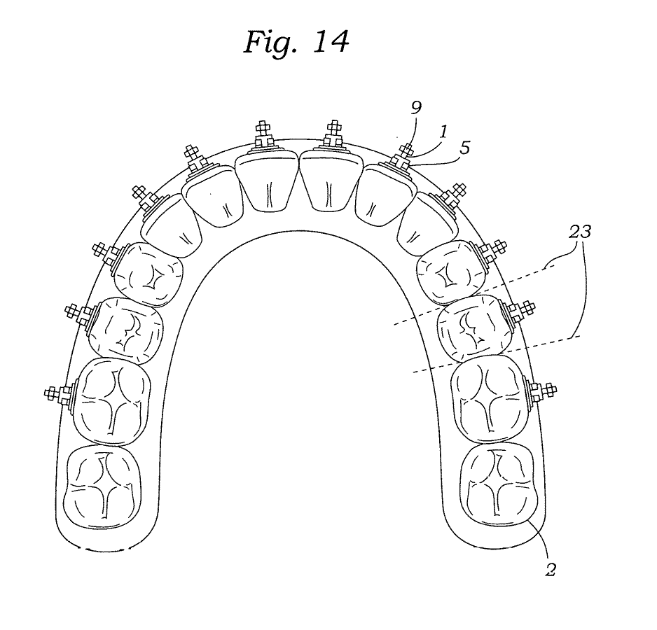

FIG. 14 shows an occlusal index 4 tray with segmental cuts 23. The occlusal index 4 is easily cut in segments to allow removal of the occlusal index 4 and to remove a single tooth segment to be used in re-bonding a bracket 5 back on a tooth 2 in its computer chosen position. The diminished axial height of the occlusal index 4 makes the cutting much easier.

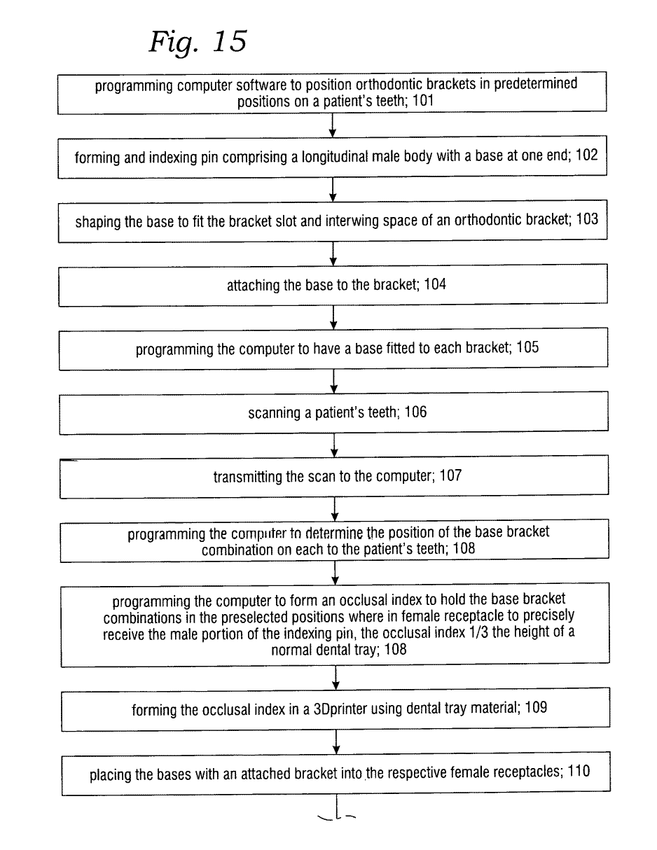

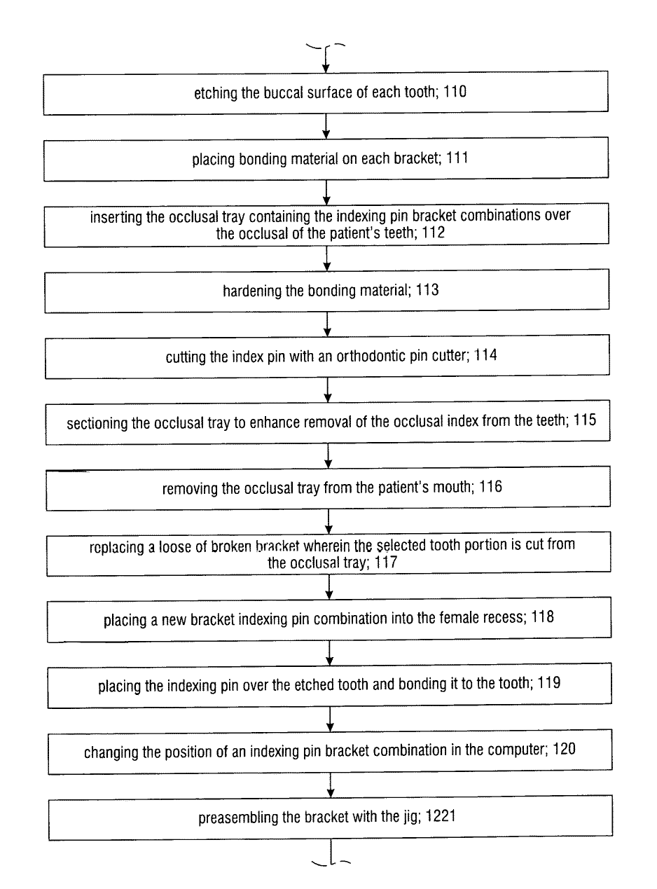

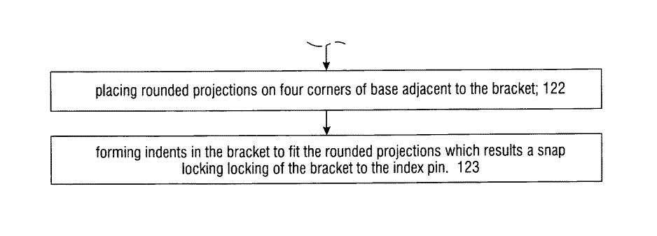

FIG. 15 discusses the method of placing the orthodontic brackets on the teeth using digital indirect bonding. The first step is programming computer software 101 to position orthodontic brackets in predetermined positions on a patient's teeth. The next step is to form an indexing pin 102 comprising a longitudinal male body with a base at one end. The base is shaped to fit 103 the bracket slot and interwing space of the orthodontic bracket. The base is attached to a bracket 104. The computer is programmed to have a base fitted to each bracket.

The patient's teeth are scanned 105. This is the preferred embodiment in the present invention; but, a set of the patient's models can be scanned. The scans are then transmitted 106 to the computer. The next step is programming the computer 107 to determine the position of the index pin bracket combination on each of the patient's teeth. The next step is programming the computer 108 to form an occlusal index which contains female geometric index pin receptacles to precisely match in shape and snap receive their respective male index pins. Each male index pin holds its respective bracket in its correct computer selected position. The occlusal index will be ⅓ the height of a normal dental tray.

The occlusal index is formed 109 in a 3D printer using dental tray material. Male index pins with their attached brackets are each placed 110 in their respective female receptacles. The patient's teeth are etched 111 where the brackets are to be placed. The next step is placing bonding material on each bracket. 112. The brackets may also be pre-pasted. The next step is inserting the occlusal tray 113 containing the indexing pin bracket combinations over the occlusal of the patient's teeth and hardening the bonding material 114.

The present invention facilitates the removal of the tray from the patient's mouth: but, if it is difficult to remove, cutting the index pins 115 with an orthodontic pin cutter makes removal very easy. Sectioning the occlusal tray 116 also enhances removal of the occlusal index. The smaller occlusal index makes cutting easy.

The next step is removing the occlusal tray 117 from the patient's mouth. Another situation involves replacing a loose or broken bracket 118 wherein the selected tooth portion is cut from the occlusal tray; Next a new bracket indexing pin combination is placed 119 into the female recess; and the indexing tray is placed over the etched tooth and the bracket is bonded 120 to the tooth. An additional situation involves changing the position of an indexing pin bracket combination 121 in the computer program and preassembling 122 the bracket with the jig.

Additional steps involve making the indexing pin snap lock with the orthodontic bracket by placing rounded projections 123 on four corners of base adjacent to the bracket; and forming indents 124 in the bracket to fit the rounded projections.

What is claimed is:

1. An indexing pin and occlusal index comprising:
An indexing pin comprising a longitudinal tail with a longitudinal male body with a first end and second end, the second end forms a base which is shaped to fit an bracket, the orthodontic bracket comprising a body, the body having a back, a front, left and right sides, an occlusal top and a gingival bottom, the body front contains an arch wire slot extending left to right, left and right tie wings separated by an interwing space wherein the base has four corners where it faces the brackets, the base is fitted to the arch wire slot and the interwing space, indexing pin attached orthodontic bracket combinations are programmed by computer software to be in the correct positions on a patient's teeth, the computer software includes an indexing pin attached to each bracket; and
an occlusal index comprised of a dental tray material to receive the indexing pin longitudinal male body and carry the attached brackets each to the patient's teeth each in the computer program chosen position.

2. An indexing pin and occlusal index of claim 1 further comprising an indexing pin made with a rigid plastic.

3. An indexing pin and occlusal index of claim 1 further comprising multiple spaced axial ridges on the longitudinal body of the longitudinal male body of the indexing pin which enhances the snap locking of the male body into the dental tray material.

4. An indexing pin and occlusal index of claim 1 further comprising an eyelet.at the first end of the longitudinal male body of the indexing pin.

5. An indexing pin and occlusal index of claim 1 further comprising computer program chosen female receptacles in the dental tray shaped to tightly receive the longitudinal male body of the indexing pin.

6. An indexing pin and occlusal index of claim 1 further comprising an index bar longitudinal tail which is straight and extends in the occlusal direction leaving a space between the longitudinal tail and tooth which leaves access to remove surplus bracket bonding material.

7. An indexing pin and occlusal index of claim 1 further comprising four rounded protrusions on the four corners of the body of the indexing pin, the orthodontic brackets have four rounded recesses located to receive the rounded protrusions when the indexing pin base is seated wherein the base is snap locked to the bracket.

8. An indexing pin and occlusal index of claim 1 further comprising female recesses in the tray material of the occlusal index, female recesses shaped to receive the longitudinal male body of the indexing pin, the shape, position and direction of each female recess selected by the computer program.

9. An indexing pin and occlusal index of claim 1 further comprising a one third height occlusal index tray wherein the tray extends axially from the occlusal of the teeth gingivally to one third the height of a fully printed tray resulting in ⅓ the 3D print time and ⅓ the material used.

10. An indexing pin and occlusal index comprising:
a rigid plastic indexing pin comprising a longitudinal tail with a longitudinal male body with first end and second ends, the second end forms a base which is shaped to fit an orthodontic bracket, the orthodontic bracket comprising a body, the body having a back, a front, left and right sides, an occlusal top and a gingival bottom, the body front contains an arch wire slot extending left to right, left and right tie wings separated by an interwing space wherein the base has four corners where it faces the brackets, the base is fitted to the arch wire slot and the interwing space, index pin attached orthodontic bracket combinations are programmed by computer software to be in the correct positions on a patient's teeth, the computer software includes each bracket attached to an indexing pin;
multiple spaced axial ridges on the longitudinal body of the longitudinal male body of the indexing pin which enhances the locking of the male body into the dental tray material;
an occlusal index comprised of a one third height dental tray to receive the indexing pin longitudinal male body and carry the attached brackets each to the patient's teeth each in the computer program chosen position wherein the tray extends from the occlusal of the teeth gingivally to one third the height of a fully printed tray resulting in ⅓ the 3D print time and ⅓ the material; and
female recesses in the tray material of the occlusal index, female recesses shaped to receive the longitudinal male body of the indexing pin, the position and direction of each female recess selected by the computer program.

11. An indexing pin and occlusal index of claim 10 further comprising an eyelet.at the first end of the longitudinal male body of the indexing pin.

12. An indexing pin and occlusal index of claim 10 further comprising an index bar longitudinal tail which is straight and extends in the occlusal direction leaving a space between the longitudinal tail and tooth which leaves access to remove surplus bracket bonding material.

13. An indexing pin and occlusal index of claim 10 further comprising four rounded protrusions on the four corners of the body of the indexing pin.

14. An indexing pin and occlusal index of claim 10 further comprising orthodontic brackets with four rounded recesses located to receive the rounded protrusions when the indexing pin base is seated, wherein the base is snap locked to the bracket.

15. A method of placing orthodontic brackets on teeth using digital indirect bonding comprising:
programming computer software to position orthodontic brackets in predetermined positions on a patient's teeth;
forming an indexing pin comprising a longitudinal male body with a base at one end;
shaping the base to fit the bracket slot and interwing space of an orthodontic bracket;
attaching the base to the bracket;
programming the computer to have a base fitted to each bracket;
scanning a patient's teeth;
transmitting the scan to the computer;
programming the computer to determine the position of the base bracket combination on each of the patient's teeth;
programming the computer to form an occlusal index to hold the base bracket combinations in the preselected positions wherein female receptacle to precisely receive the male portion of the indexing pin, the occlusal index ⅓ the height of a normal dental tray;
forming the occlusal index in a 3D printer using dental tray material;
placing the bases with an attached bracket into the respective female receptacles;
etching the buccal surface of each tooth;
placing bonding material on each bracket;
inserting the occlusal tray containing the indexing pin bracket combinations over the occlusal of the patient's teeth;
hardening the bonding material;
removing the occlusal tray from the patient's mouth;
cutting the index pins with an orthodontic pin cutter;
replacing a loose or broken bracket wherein the selected tooth portion is cut from the occlusal tray;
placing a new bracket indexing pin combination into the female recess; and
placing the indexing pin over the etched tooth and bonding it to the tooth.

16. The method of claim 15 further comprising:
changing the position of an indexing pin bracket combination in the computer program.

17. The method of claim 15 further comprising:
clipping the indexing pin with orthodontic pin cutters to enhance removal of the occlusal tray from the teeth.

18. The method of claim 15 further comprising:
sectioning the occlusal tray to enhance removal of the occlusal index from the teeth.

19. The method of claim 15 further comprising:
preassembling the bracket with the jig.

20. The method of claim 15 further comprising:
placing rounded projections on four corners of base adjacent to the bracket; and
forming indents in the bracket to fit the rounded projections which results in a snap locking of the bracket to the index pin.
